(19) United States
(12) Patent Application Publication
(10) Pub. No.: US 2018/0334023 A1
(43) Pub. Date: Nov. 22, 2018

(54) ENGINE SUPPORT

(71) Applicant: Schaeffler Technologies AG & Co. KG, Herzogenaurach (DE)

(72) Inventors: Hartmut Krehmer, Erlangen (DE); Harald Hochmuth, Hagenbuchach (DE); Daniel Faber, Nurnberg (DE); Alexander Hausmann, Erlangen (DE)

(73) Assignee: Schaeffler Technologies AG & Co. KG, Herzogenaurach (DE)

(21) Appl. No.: 15/777,776

(22) PCT Filed: Nov. 10, 2016
(86) PCT No.: PCT/DE2016/200517

§ 371 Date: May 21, 2018

(30) Foreign Application Priority Data
Nov. 19, 2015 (DE) 10 2015 014 953.9
Apr. 20, 2016 (DE) 10 2016 206 699.4

(51) Int. Cl. B60K 5/12; F16F 7/02

(52) U.S. Cl. CPC B60K 5/12; F16F 2222/04; F16F 2228/066; F16F 7/023

(57) ABSTRACT

An engine support (1) for preventing a linear movement, including a clamping element-blocking unit (3) that has two switched states, a housing (4) that is located radially outside the clamping element-blocking unit (3), and a rod (2); in the open switched state, the rod (2) can move linearly relative to the housing (4), and in the closed switched state, a relative linear movement between the rod (2) and the housing (4) is prevented; the clamping element-blocking unit (3) includes two clamping element cages (6, 7) which are located axially next to each other and in which a plurality of clamping elements (10) are guided, and also includes at least one spring (11, 16), the blocking effect being created by axially moving the clamping element cages (6, 7) towards each other.

### BACKGROUND

The invention relates to an engine support for supporting an internal combustion engine.

In DE 199 29 866 A1, a device for supporting an internal combustion engine against rolling movements is disclosed. The device is provided at least with an oscillation-damping engine support element that has predefined constant stiffness and damping characteristics. To reduce the rolling movements of the internal combustion engine due to the drive torque, it is provided that in addition to the engine support element, a force application device is provided that acts on the internal combustion engine against the rolling movements in parallel to the spring and damping force of the engine support element at least in certain engine operating ranges.

In DE 697 05 374 T2, a hydraulic, oscillation-damping bearing is disclosed that is provided for arrangement between two rigid elements for damping and reducing vibrational movements between these two elements.

### SUMMARY

The object of the present invention is to disclose a device for supporting an internal combustion engine that is improved and refined in comparison with the prior art, in which the transfer of oscillations and vibrations of an internal combustion engine to the passenger compartment is reduced.

To achieve this objective according to the invention, the engine support having one or more features of the invention is provided. Optional advantageous constructions of the invention are produced completely or partially from the description and claims that follow.

The invention emerges from the following preliminary considerations: for automatic start or stop processes, undesired oscillations or vibrations of the internal combustion engine can be transferred either via the engine support or via the drivetrain into the body or into the interior of a passenger compartment. These vibrations are perceived as a significant deterioration of comfort. Here, the perceived driving comfort is essentially dependent on the hardness of the whole suspension of the drivetrain relative to the vehicle body. A soft suspension means increased driving comfort but is associated with worse response in acceleration processes and worse response in engine braking. Thus, the design of the suspension of the drivetrain is always a compromise between these competing development goals. Especially with the reduction of the number of cylinders, more and more vibrations are generated by the drivetrain. These vibrations are especially critical for the perceived comfort in vehicles with start and stop systems, because here, for each start and stop process, the engine runs through resonance-critical rotational speed ranges. Thus, there is a need for other solutions particularly for these vehicles.

Typically, vibration dampers, tuned mass dampers, or soft, sometimes also switchable, engine mounts are used for increasing comfort. To improve the response of the vehicle again, in turn, additional supports of the engine relative to the body are introduced. These, however, have a negative effect on driving comfort again.

The engine support according to the invention for supporting an internal combustion engine has a clamping element/blocking unit with two switch states, a housing arranged radially outside of the clamping element/blocking unit, and a rod. The two switch states are an open and a closed or blocked switch state. In the open switch state, the rod is movable in a linear fashion relative to the housing, that is, axially relative to the longitudinal axis of the rod. In contrast, in the closed switch state, a relative linear movement between the rod and housing is blocked. The clamping element/blocking unit has two clamping element cages that are arranged axially one next to the other and guide a plurality of clamping elements, as well as at least one spring, wherein the blocking effect or braking effect is produced by axial movement of the clamping element cages relative to each other. Here, either only one clamping element cage or two clamping element cages can be moved. The movement of the clamping element cages is here oriented in a linear fashion, starting from the longitudinal axis of the rod. According to the construction, one of the clamping element cages can also be moved rotationally relative to the second clamping element cage. The rod can have, for example, a circular cross section, a cross section with raceways for the clamping elements, wherein the raceways are preferably constructed as longitudinal grooves, or a hexagonal cross section.

With the engine support according to the invention, the oscillations and vibrations of an internal combustion engine relative to a vehicle body are preferably reduced during the automatic start or stop processes of the internal combustion engine.

Preferably, both clamping element cages are constructed as identical parts. The two identically constructed clamping element cages here have a reflection symmetrical arrangement axially one next to the other, so that an axis symmetry is produced between the two facing end sides.

The clamping elements guided in the clamping element cages are preferably constructed as balls or rollers. The rollers can have, for example, a cylindrical shape or a bone-like shape, that is, a cylindrical shape with a lateral contraction in the middle.

Preferably, the engine support has a ramp contour on the inner wall of the housing. The designation “ramp contour” is understood to be a simple ramp contour. A “double ramp contour” is understood to be two inclines running toward each other. The double ramp contour thus has the shape of a roof, wherein the inclines do not necessarily have to intersect each other. Both inclines of the double ramp contour represent the clamping surfaces for the clamping elements, wherein each incline can be brought into connection with the clamping elements of one of the clamping element cages. This means that each incline of the double ramp contour is allocated to a clamping element cage. However, it is also conceivable that two simple ramp contours are formed on the inner wall of the housing. A “simple ramp contour” is understood to be an incline running at an angle to the longitudinal axis. The incline of the simple ramp contour represents a clamping surface for the clamping elements. The surface of the rod represents another clamping surface, so that the clamping elements are clamped between the rod and the ramp contour, especially the simple ramp contour or double ramp contour. Preferably, each incline of the ramp contour encloses an angle between 1° and 15° with the longitudinal axis of the rod.

The ramp contour is integrated directly, for example, in the housing. This means that the inner wall of the housing is constructed as a ramp contour, for example, two simple ramp contours or one double ramp contour. Another possibility is provided in that the ramp contour is constructed on at least one add-on element and the add-on element is arranged on the inner wall of the housing. For the use of a double ramp contour, preferably only one add-on element is used that is arranged between two clamping element cages. In contrast, for the use of two simple ramp contours, two add-on elements can be used that are each arranged axially outside of the two clamping element cages. However, it is also possible that two simple ramp contours are integrated in one add-on element.

In one possible embodiment, the add-on element is connected rigidly to the housing. Here, the add-on element can be constructed as a sliding bearing for the rod and thus has suitable sliding properties on its inner wall. In an alternative embodiment, the add-on element is arranged so that it is movable in a linear fashion on the inner wall of the housing. Here it is preferred when the add-on element has suitable sliding properties on its outer wall. Both embodiments are also possible with the use of two or more add-on elements.

In another example embodiment, corresponding contours that engage in each other during one switch state are present on the facing end sides of the clamping element cages. For example, the contours are constructed as tooth contours or as serrated contours. Preferably, at least one actuation element is arranged on a clamping element cage, wherein an adjustment movement of the clamping element cage is achieved by the actuation element, which opens the teeth of the tooth contour and thus moves the clamping element cages relative to each other. This means that a linear movement of the two clamping element cages relative to each other is generated by a rotational movement of the clamping element cage. In this embodiment, one of the clamping element cages is secured against rotation relative to the housing. The other clamping element cage can, in contrast, be rotated relative to the housing so that by use of the tooth contours on the end sides of the clamping element cages, an axial movement of the two clamping element cages is produced. The maximum axial movement here corresponds to the length of one tooth height of the tooth contour. In this way, the second switch state is achieved. In order to achieve the first switch state again, preferably both clamping element cages are connected to respective return springs that bring the clamping element cages back into their original position. The actuation elements are preferably formed as bolts.

Furthermore, the engine support according to the invention preferably has an actuator, in particular, a solenoid, which actuates the clamping element/blocking unit and switches back and forth between both switch states.

The engine support according to the invention is arranged as a switchable support between the internal combustion engine and vehicle body or sub-frame. For this purpose, the rod is connected to the internal combustion engine or to the vehicle body. The part not connected to the rod is connected to the housing of the engine support.

Preferably, in the normal driving mode of the vehicle, the open switch state of the engine support is actuated. This means that a movement of the internal combustion engine relative to the vehicle body is enabled. This resulting degree of freedom can lead undesired oscillations and vibrations that are caused, for example, by automatic start/stop processes, into the interior of the vehicle. To avoid any resulting deterioration of comfort, the engine support is switched into the closed switch state for the start-up process. In this way, the movement of the internal combustion engine relative to the vehicle body is disabled.

### BRIEF DESCRIPTION OF THE DRAWINGS

Additional details, features, feature combinations, and effects on the basis of the invention are given from the following description of preferred, example embodiments of the invention and from the drawings. Shown in these figures are:

FIG. 1 a first embodiment of an engine support according to the invention in the closed switch state in section view,

FIG. 2 the first embodiment of the engine support in the open switch state in section view,

FIG. 3 the first embodiment of the engine support in perspective view,

FIG. 4 a section view of the first embodiment of the engine support with example surrounding construction,

FIG. 5 the front view of the example surrounding construction, and

FIG. 6 a second embodiment according to the invention of the engine support in section view.

### DETAILED DESCRIPTION

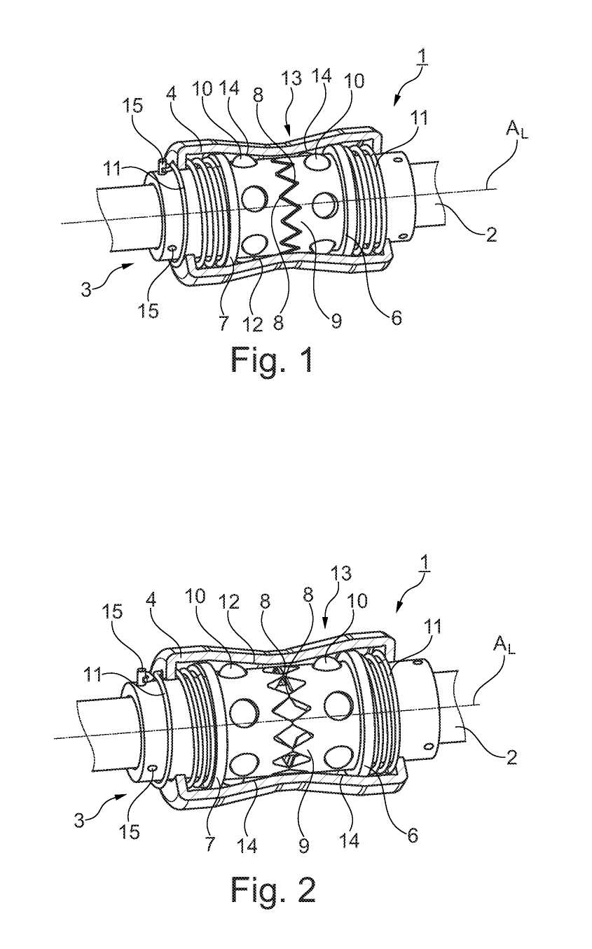

In FIGS. 1 to 5, a first embodiment of an engine support 1 according to the invention is shown in different views and in different switch states. The engine support 1 has a rod 2 with a longitudinal axis A_{L}, a clamping element/blocking unit 3, and a housing 4. The rod 2 has a circular cross section. In addition, the rod 2 is connected to the internal combustion engine not shown here. The housing 4 is connected, for example, as shown in FIG. 4, by a housing connection 5 that represents the surrounding construction, to the vehicle body also not shown here.

The clamping element/blocking unit 3 has two clamping element cages 6, 7 that are arranged axially next to each other starting from the longitudinal axis A_{L} of the rod 2. The clamping body cages 6, 7 are constructed as identical parts and are each surrounded partially by the housing 4. In addition, the clamping element cages 6, 7 are in a reflection-symmetric arrangement. That is, they have axis symmetry of the two clamping element cages 6, 7 from the facing end sides 8. The first clamping element cage 6 is secured against rotation relative to the housing 4, while the second clamping element cage 7 is supported so that it can rotate relative to the housing 4.

The facing end sides 8 of the clamping element cages 6 each have a contour 9 that engage in each other in the closed switch state of the engine support 1. The contour 9 is constructed here as a tooth contour. The closed switch state is shown in FIG. 1 and in FIG. 4.

In addition, a plurality of clamping elements 10 constructed here as balls are guided in both clamping element cages 6, 7. The clamping elements 10 are arranged in a row in the circumferential direction of the clamping element cage 6, 7. The rod 2 that can move in a linear fashion is supported so that it can move by these clamping elements 10 and is guided within the housing 4.

The clamping element cages 6, 7 are each spring-loaded by a return spring 11. The return springs 11 are constructed as compression springs and are each supported on the clamping element cage 6, 7 and also on the housing 4. In the closed switch state shown in FIG. 1, the return springs 11 press the clamping element cages 6, 7 against each other so that the contours 9 engage in each other completely.

The housing 4 has an integrated double ramp contour 13 on the inner wall 12 according to FIG. 1 to FIG. 5. The double ramp contour 13 comprises two inclines 14 running toward each other, wherein the inclines 14 represent the clamping surfaces for the clamping elements 10. The angle between the two inclines 14 is greater than 150°. The double ramp contour 13 is arranged in the housing 4 such that in the closed switch state, the clamping elements 10 are pressed against the inclines 14 so that a clamping effect is created between the rod 2 and housing 4. Here, the clamping elements 10 of the first clamping element cage 6 press against an incline 14 and the clamping elements 10 of the second clamping element cage 7 press against the other incline 14 of the double ramp contour 13. Thus, the linear movement capability of the rod 2 is blocked and the engine support 1 is located in the closed switch state.

To release the clamping effect, on the second clamping element cage 7 that is supported so that it can rotate, three actuation elements 15 are located axially outside of the housing 4. The actuation elements 15 perform an adjustment movement by which the second clamping element cage 7 is rotated relative to the housing by a rotary actuator that is attached concentric to the housing and is not shown here. Optionally, the actuation elements could perform the adjustment movements by a linear actuator attached outside of the housing. Through this rotational movement of the second clamping element cage 7, an axial movement component by which the two clamping element ages 6, 7 are pressed apart from each other against the forces of the two return springs 11 is produced by the contours 9 of the two clamping element cages 6, 7 that engage in each other. In this way, the clamping elements 10 are also moved axially away from the double ramp contour, so that the clamping with the inclines 14 of the housing 4 is released. Thus, the rod 2 supported by the clamping elements 10 can move freely in the axial direction again. The engine support 1 is consequently located in the open switch state, which is shown in FIG. 2.

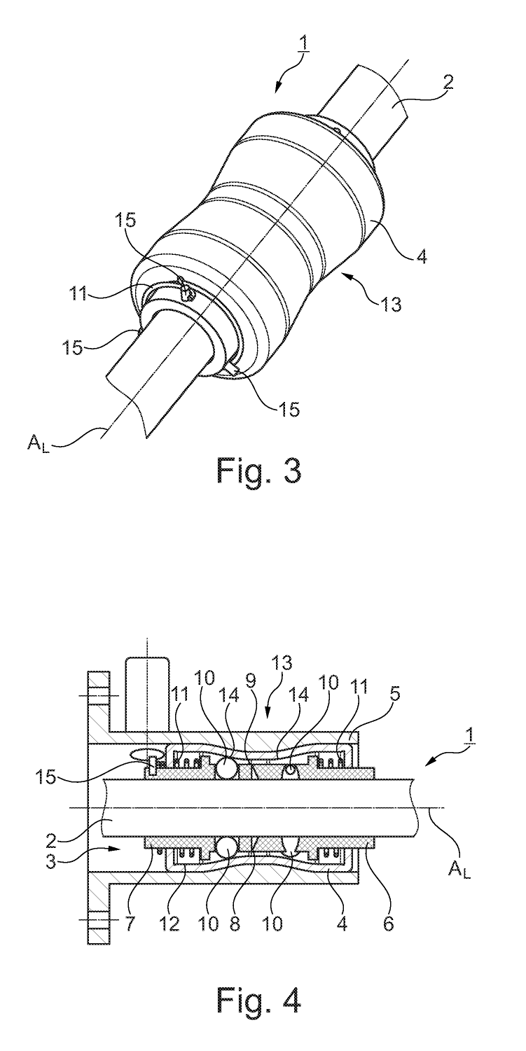

In FIG. 3, the engine support 1 is shown in a perspective view. Here, the three actuation elements 15 and the return spring 11 placed around one of the actuation elements 15 can be seen. This arrangement of the return spring 11 ensures that the engine support 1 can be moved into its original state again after the rotational movement introduced by the actuator, that is, in this case, into the closed switch state, in that the clamping element cage 7 is rotated back into its original position by this return spring 11.

In the construction of the engine support 1 described here, this is closed in the normal state and can be opened by the rotational movement of a clamping element cage 7. Deviating from this arrangement, by the construction of the facing end sides of the clamping element cages and by the dimensioning of the return springs, the engine support can be designed so that it is open in the normal state and can be actively closed by a rotational movement.

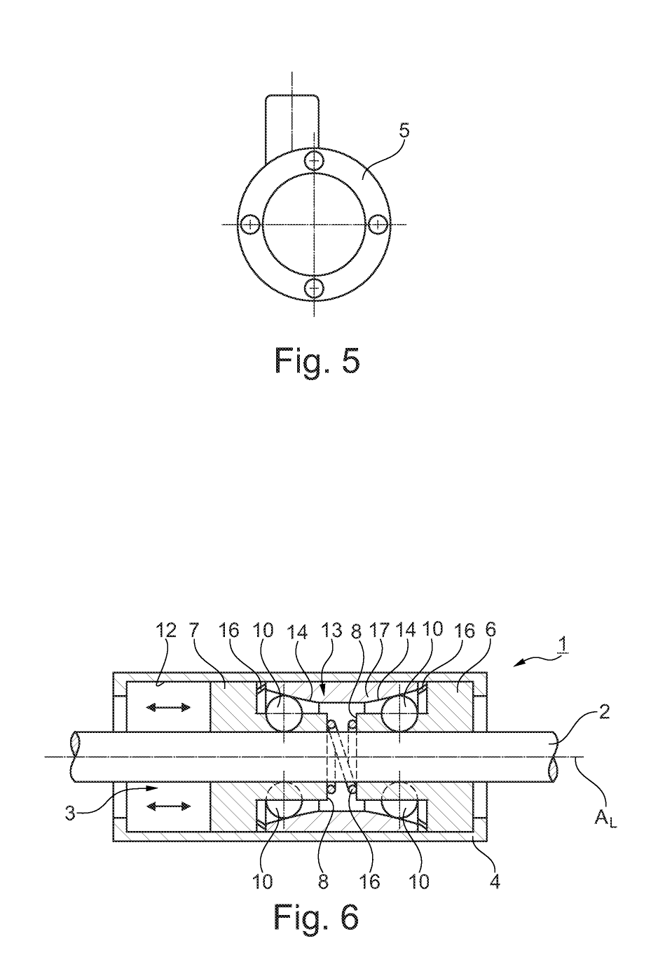

In FIG. 4 and FIG. 5, an example surrounding construction is shown in section view and in front view. As already described above, the surrounding construction in this case represents a housing connection 5 that is connected to the vehicle body. The housing connection 5 has a flange-like shape in which the engine support 1 is arranged. The engine support 1 is here pressed into the housing connection 5 and can be connected to the vehicle body using screws.

In FIG. 6, a second preferred embodiment of the engine support 1 according to the invention is shown. In contrast to the first embodiment, switching is done between the closed and open switch state only by the axial movement of a clamping element cage 7. The normal state of the illustrated engine support 1 is here open and can be actively closed by axial movement of a clamping element cage 7. So that, starting from the closed switch state, the open switch state can be achieved again, a compression spring 16 is arranged between the facing end sides 8 of the two clamping element cages 6, 7, wherein this spring guarantees the release of the clamping effect. In addition, the first clamping element cage 6 contacts the housing 4 directly in the axial direction, so that this cannot perform linear movement.

In addition, on the inner wall 12 of the housing 4 there is an add-on element 17 that has a double ramp contour 13 and is movable in a linear fashion on the inner wall 12 of the housing 4. The inner wall 12 of the housing 4 has a flat construction in the axial direction. The double ramp contour 13 is formed as in the first embodiment. The housing is here produced as a molded part and represents a sheet-metal sleeve.

Both clamping element cages 6, 7 have a series of clamping elements 10 that are constructed as balls in the circumferential direction as per FIG. 1.

Axially between the add-on element 17 and the two clamping element cages 6, 7 there is a compression spring 16 that is here constructed as a corrugated spring. These two compression springs 16 ensure the release of the clamping effect as in the first embodiment.

In order to achieve the closed switch state, the second clamping element cage 7 is moved axially against the forces of the compression springs toward the other clamping element cage 6. In this way, the add-on element 17 is also moved axially in the direction of the first clamping element cage 6 until all three compression springs 16 have reached their minimum spring length. Simultaneously, the double ramp contour 13 of the add-on element 17 is constructed so that the clamping elements 10 achieve a clamping effect with the double ramp contour 13 for the minimum length of the springs 16. In this way, the closed switch state is reached and the linear movement capability of the rod is stopped.

This switch state is released in that the second clamping element cage 7 is pushed away linearly from the first clamping element cage 6 again. By the use of the compression springs 16, the clamping is released and all elements 7, 17 of the clamping element/blocking unit 3 are brought into their original state. Thus, the rod 2 can move freely again and the engine support 1 is located in the open switch state.

### LIST OF REFERENCE SYMBOLS

1 Engine support

2 Rod

3 Clamping element/blocking unit

4 Housing

5 Housing connection

6 First clamping element cage

7 Second clamping element cage

8 Facing end side of the clamping element cage

9 Contour

10 Clamping element

11 Return spring

12 Inner wall of the housing

13 Ramp contour

14 Incline

15 Actuation element

16 Compression spring

17 Add-on element

A_{L} Longitudinal axis of the rod

1. An engine support for supporting an internal combustion engine, comprising a clamping element/blocking unit with open and closed switch states, a housing arranged radially outside of the clamping element/blocking unit, and a rod that extends axially through the clamping element/blocking unit, such that in the open switch state, the rod is movable in a linear fashion relative to the housing and, in the closed switch state, a relative linear movement between the rod and housing is blocked, the clamping element/blocking unit comprises two clamping element cages arranged axially one next to the other, a plurality of clamping elements guided in the clamping element cages, as well a and at least one spring, the clamping element cages being axially movable relative to each other to generate a blocking effect.

2. The engine support according to claim 1, wherein the clamping element cages are constructed as identical parts.

3. The engine support according to claim 1, wherein the clamping elements are constructed as balls.

4. The engine support according to claim 1, further comprising a ramp contour located on an inner wall of the housing.

5. The engine support according to claim 4, wherein the ramp contour is located on an add-on element and the add-on element is arranged in a linearly movable fashion on an inner wall of the housing.

6. The engine support according to claim 4, wherein the ramp contour encloses with a longitudinal axis (A_{L}) of the rod an angle between 1° and 15°.

7. The engine support according to claim 1, further comprising corresponding contours that engage in each other in exactly one switch state are located on facing end sides of the clamping element cages.

8. The engine support according to claim 7, further comprising at least one actuation bolt arranged on one of the clamping element cages, said actuation bolt being configured to move the clamping element cage by an actuation movement in order to open teeth of the tooth contour.

9. The engine support according to claim 1, further comprising an actuator actuates the clamping element/blocking unit and switches back and forth between the open and closed switch states.

10. An engine support for supporting an internal combustion engine, comprising:
a clamping element/blocking unit with open and closed switch states,
a housing arranged radially outside of the clamping element/blocking unit,
a rod that extends axially into the clamping element/blocking unit such that in the open switch state, the rod is movable in a linear fashion relative to the housing and in the closed switch state, a relative linear movement between the rod and housing is blocked,
the clamping element/blocking unit comprises two clamping element cages arranged axially one next to the other, at least one clamping element guided in each of the clamping element cages, and at least one spring that biases the clamping element cages axially at least one of toward or away from one another.

11. The engine support according to claim 10, further comprising an actuator that moves the clamping element cages in axial direction to switch between the open and closed switch states.

12. The engine support according to claim 10, further comprising a ramp contour located on an inner wall of the housing.

13. The engine support according to claim 12, wherein the at least one clamping element in each of the clamping element cages is a rolling element that travels on the ramp contour between an open position and a blocking position in which the rolling elements block axial movement of the rod as the clamping element/blocking unit switches from the open switch state to the closed switch state.

14. The engine support according to claim 12, wherein the ramp contour is located on an add-on element arranged in a linearly movable fashion in the housing.

15. The engine support according to claim 10, wherein the housing includes an integrated double ramp contour, and a respective one of the at least one clamping element guided in each of the clamping element cages is located on each ramp of the double ramp contour.

16. The engine support according to claim 15, wherein the at least one clamping element guided in each of the clamping element cages comprises a respective series of clamping elements that extend in a circumferential direction.

17. The engine support according to claim 16, wherein the respective series of clamping elements are guided on respective ones of the ramps of the double ramp contour.

18. The engine support according to claim 10, further comprising corresponding ramp contours that engage in each other located on facing end sides of the clamping element cages such that a relative rotation of the clamping element cages causes an axial relative movement of the clamping element cages.

19. The engine support according to claim 10, wherein a first one of the clamping element cages is configured to rotate relative to the housing, and a second one of the clamping element cages is configured to not rotate relative to the housing.
